(19) United States
(12) Patent Application Publication
(10) Pub. No.: US 2022/0112099 A1
(43) Pub. Date: Apr. 14, 2022

(54) ARRANGEMENT (DEVICE) FOR CONVERSION OF WATER CONTAMINATED WITH HARMFUL ELEMENTS INTO CERTIFIED ECOLOGICAL, HEALTHY WATER WITH NATURAL CLEANING OF WATER WITHOUT FILTERS

(71) Applicants: Nikolaos TSAGKAS, Xanthi (GR); Ioannis TSAGKAS, Patra (GR); Alexandros TSAGKAS, Ptolemaida (GR); Fotios TSAGKAS, Xanthi (GR)

(72) Inventors: Nikolaos TSAGKAS, Xanthi (GR); Ioannis TSAGKAS, Patra (GR); Alexandros TSAGKAS, Ptolemaida (GR); Fotios TSAGKAS, Xanthi (GR)

(21) Appl. No.: 17/535,990

(22) Filed: Nov. 27, 2021

Related U.S. Application Data
(63) Continuation of application No. PCT/GR2020/000025, filed on May 25, 2020.

(30) Foreign Application Priority Data
May 28, 2019 (GR) 20190100232

(51) Int. Cl. C02F 1/04; B01D 1/00; B01D 1/30; B01D 5/00; C02F 1/48

(52) U.S. Cl. CPC C02F 1/043; B01D 1/0017; B01D 1/30; B01D 5/0006; B01D 5/006; C02F 1/48; C02F 2101/163; C02F 2201/001; C02F 2209/02; C02F 2209/005; C02F 2209/42; C02F 2209/44; C02F 2303/04; C02F 2201/007

(57) ABSTRACT

The operation of the arrangement (device) for conversion of contaminated (loaded) water with harmful substances and elements into certified ecological, healthy water, with natural cleaning without filters, is based on the production of water vapor by heating water in a stainless steel chamber and channeling (water vapor drain) of water vapor with air flow to the liquefaction system This model works without filters, membranes or chemicals and additionally is not including other harmful substances and elements that burden, pollute, infect and contaminate the environment. Ecologically it transforms the unsuitable for health water into the excellent quality healthy drinking water. Nitrates, which are converted to nitrites (NO2) when boiled in water, can be converted into one of the most potent carcinogenic compounds, nitrosamines. The arrangement (device) includes a container (Cx), with two electrodes, that communicates with the boiling chamber, to control the limits of the boiling water level, to eliminate parasitic electromagnetic fluctuations and to avoid oxidation of the two electrodes.

### FIELD OF THE INVENTION

The operation of the above system is based on the production of water vapor by increasing the temperature of the contaminated with harmful elements water in a stainless steel chamber and channeling the water vapor in a liquefaction system, with the help of rapid air flow, where the boiling speed is proportional to the heating that increases the temperature of the burdened water and inversely proportional to the pressure exerted on the surface of the contaminated water.

Also the evaporation rate for water vapor production is inversely proportional to this pressure. Water vapor has a high escape rate from the exit of the boiling chamber to the water vapor liquefaction system, when a high-velocity atmospheric air flow is channeled to the water vapor liquefaction system and to the stainless steel water collection chamber.

The flow of air to the stainless steel drinking water collection chamber, through a layer of useful elements, reduces the temperature of the water vapor, participating in their liquefaction and enriching the drinking water with beneficial elements, which is further processed by adding useful elements. The proposed ARRANGEMENT, (DEVICE) according to the present invention, includes as a feature, the addition of a small cylindrical container, which communicates with the boiling chamber through the bottoms by a tube, where two electrodes are introduced into the container to control the boiling water levels, in the boiling chamber.

The addition of the container is done with the aim of a) eliminating parasitic electromagnetic fluctuations due to fluctuations of the surface by boiling water in the boiling chamber and b) avoiding the oxidation that the two electrodes will undergo at the high temperature of the boiling chamber.

A stainless steel collection chamber of drinking water is connected to one end of a spiral, serpentine stainless steel piping for air-cooled evaporation of water vapor and the other end of the serpentine communicates with the boiling chamber through a stainless steel vertical pipe to separate water vapor from non-drinking water droplets.

Two taps, one for the exit of drinking water and the other for the exit of the residues from the loaded water that have been boiled, for a period of 24 hours or more.

The certified laboratory EMC HELLAS of European standards tested the industrial standard for CE, which passed all 100% tests of electromagnetic compatibility and the LVD has been implemented.

The arrangement (device), as the new technology of vaporization of non-drinking water, provides healthy drinking water, enriched with beneficial elements and O 2, N 2, from the atmospheric air, upgrading the quality of life of users.

The device is functioning without the use of filters, membranes, chemicals or other harmful substances, which are expensive and work in reverse after saturation at an indefinite time and mainly pollute the environment.

As a home appliance in times of water shortage it is valuable. It has low production cost in order to promote it globally with the expectation that it will be widely accepted.

The device's most important benefit is its unique method that purifies water from all carcinogenic toxic substances and especially from the most dangerous for health soluble in water which are nitrates, arsenic and radioactive isotopes, (Cs-137, Sr-90), this is the one of the main advantages for the spread of the arrangement (device) worldwide.

In addition, as a home appliance, during periods of water shortage, it can use water from solar heating for energy saving, snow, sea water, water from tank, pool, river, drilling or water from sources of dubious quality contaminated (loaded) with toxic elements from polluted groundwater or contaminated (loaded) with radioactivity etc.

From the results, mentioned in the report of chemical analysis/examination of Q&Q Analysis, and the general chemistry of the state, it is concluded that in the water of Xanthi (a city located in Northern Greece) that have been processed with the device of conversion of non-drinking water into ecological drinking water, Nitrates, Chlorides and Calcium are detected at low concentrations, (avoiding nephrolithiasis and safe limits for dangerous ones), while the same water that have not been treated with the conversion arrangement (device), the concentrations are high in Nitrates, 41.8 mg/L (safe 10 mg/L), Chlorides are 26.6 mg/L, Sulfates are 37, 8 mg/L and Calcium is 70.2 mg/L. About the danger of nitrates it is reported in the international literature and on the Internet that nitrates are converted to nitrites (NO 2) which are converted during boiling into one of the most potent (strongest) carcinogenic compounds, the nitrosamines, which are hepatotoxic (nitrogen paralysis). The arrangement (device) produces a financial viable solution to remove nitrates from water.

### DETAILED DESCRIPTION OF THE PREFERRED INTEGRATED APPLIANCES

2. Description of existing technology. A) Steaming and liquefaction methods with cooling water. B) Electrolysis method. C) Reverse osmosis method. D) Method of production of drinking water with solar energy.

3. Disadvantages of existing technology. a) An important part of the thermal energy is lost. b). Membranes and filters have a short lifespan and high cost. c). No total salt excretion is achieved. d). The performance in the mentioned systems is small, e). Chemicals are used that pollute the environment, g). Harmful Electromagnetic Radiation (EMR).

### SUMMARY OF INVENTION

The first purpose of this invention is to provide a low-cost device, in ecological production of pure drinking water, according to all terms of hygiene, user-friendly, using low-consumption electricity, safe, functionally reliable and generally useful. This goal can be achieved with the help of devices, mechanisms and components of existing technology, significantly reducing system costs.

The second purpose is to provide an arrangement (device) that can be used, either en masse for large numbers of users in areas of water scarcity or in areas of questionable quality of drinking water, which includes communities, islands, ships, etc., or for a small number of users typically including a family.

This purpose can be achieved with the help of a flexible system which, depending on the size of the mechanisms and components of its construction, can be used, either en masse for a large number of users, or for a small number of users.

The third purpose of this invention can be implemented with the help of the proposed device, so that it is environmentally friendly, with less thermal pollution and waste, which will produce drinking water according to all hygienic conditions.

### BRIEF DESCRIPTION OF DRAWINGS

The application of the invention is described below with reference to the accompanying drawings

FIG. 1 shows a general overview of the arrangement (device) which, according to the present invention, is characterized by the fact that it consists of several sections and mechanisms such as:

A stainless steel chamber for boiling and evaporating the contaminated water and another chamber for filling with drinking water, two electrodes for controlling the level limits, in a container, which communicates with the first chamber by a pipe, where the role of adding this container is described in paragraph with a detailed description of the preferred built-in applications, a stainless steel tube for transporting and separating droplets from water vapor, a stainless spiral piping (serpentine) for liquefaction of water vapor, two taps, two switches (one for the general operation and another one for electric power supply for water boiling), a 12V power supply, a rectifier circuit with diode and capacitor (alternatively is not necessary) a 12V level regulator, an electromechanical (HM) valve, a tank heated by the solar panel, an air inlet pump in the same direction as the water vapor, an electric ohmic resistance heating and various other economical heating mechanisms, a powerful blower as a 12 Volt air-cooled mechanism, a relay, a float, a timer, two thermostats for a set and adjustable temperature. Also in some cases for increased production of drinking water, a quick cooling mechanism can be used with a multifunction fan and thermoelectric cooling (Peltier effect) a horizontal layer of suitable materials to improve water quality, air intake mechanisms in non-drinking and drinking water chambers, a mechanism for transporting water vapor that has not been liquefied to the drinking water chamber, a feedback control valve, a microcontroller or a microprocessor operation of the whole system. Alternatively some of the above sections and mechanisms which will be mentioned in the next paragraph are not necessary for the operation of the device. (Gx2)

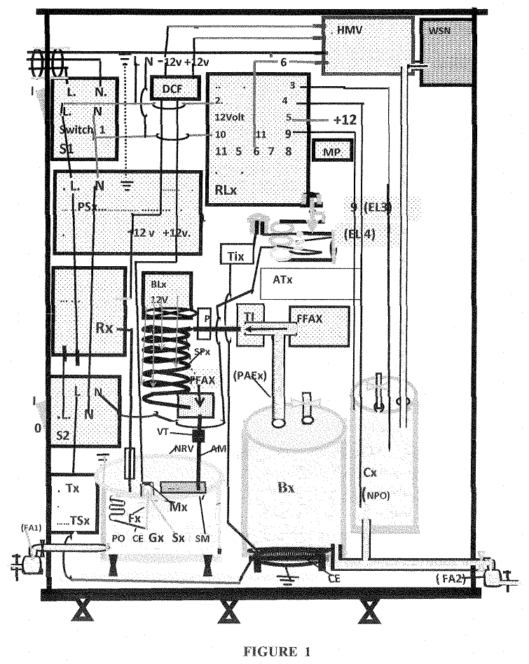

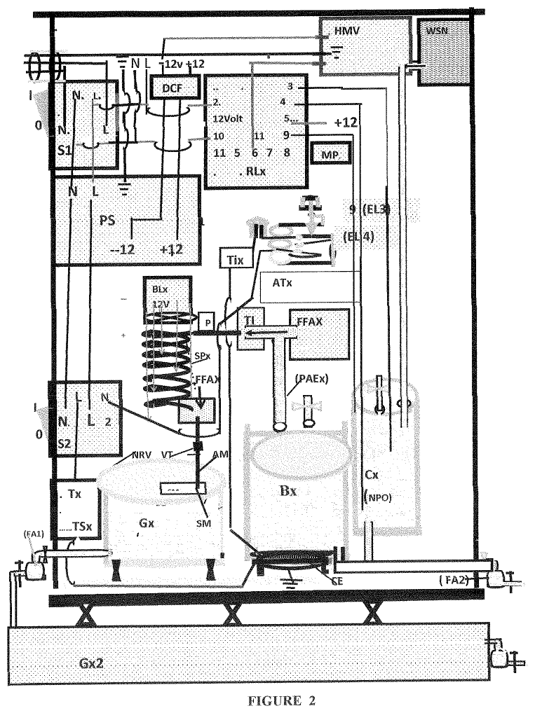

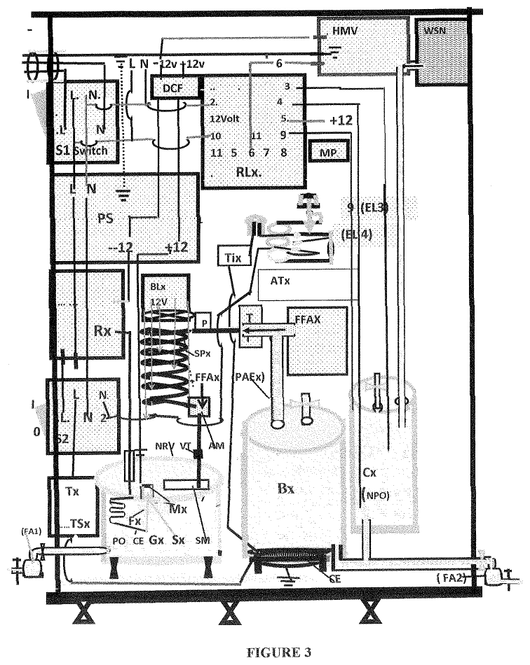

FIG. 2 shows an alternative view of the layout of FIG. 1, with the difference that it includes an additional Gx2 chamber for drinking water and FA3 drinking water transport pipe to Gx2, that it has different connections to switches S1, S2 and not includes a relay and a float.

FIG. 3 also shows an alternative view of the layout of FIG. 1, with the difference that it has different connections on switches S1 and S2

### DETAILED DESCRIPTION OF THE PREVIOUS (PREFERRED) INTEGRATED APPLICATIONS (APPLIANCES)

The detailed description of the preferred integrated applications (appliances) made with reference to the accompanying drawings does not intend to limit the scope of the invention and will be understood by an experienced, specialist, technologist, examiner, that this invention has not been foreseen by existing technology.

FIG. 1 shows an overview of the improved arrangement (device) of conversion order of contaminated (polluted or charged) water loaded with harmful substances into certified ecological healthy (hygiene), drinking water with natural cleaning, without filters, which according to the first preferred built-in application of this invention, is characterized by the fact that it consists of:

1. One stainless steel chamber for boiling and two stainless steel chambers (Gx1) (Gx2) for drinking water, a pipe with two rectangular corners to transport drinking water from (Gx1) to (Gx2),

to the second chamber for drinking water,

2. A small container (Cx), preferably cylindrical, communicating with the boiling chamber (Bx), preferably through the bottoms of (Cx) and (Bx) by a pipe for the purpose:

a) Of the elimination of parasitic electromagnetic fluctuations due to fluctuations of the surface of boiling water, in the boiling chamber, and

b) To avoid the oxidation that the two {(3), (4)} electrodes will undergo at the high temperature in the boiling chamber (Bx).

3. two stainless steel chambers (Gx1) (Gx2) for drinking water (PO) with metallic cover (NRV), a pipe with two rectangular corners to transport drinking water to the second chamber (Gx2) for drinking water,

4a. A spiral (SPx) (serpentine coil) stainless steel piping for air-cooled water vaporization, where one end of the serpentine coil communicates with the drinking water chamber (Gx) and the other end with the boiling chamber (Bx) through.

4b. A stainless steel vertical pipe (PAEx) of suitable length and shape for separating water vapor from non-drinking water droplets.

5. Two autlet taps, one (FA1) for the exit of drinking water (PO) and the other (FA2) for the exit of waste water from the overloaded water (NPO) that have been boiled for a certain period of 24 hours and more.

6. Two electrodes-sensors (EL3) and (EL4) which are inserted (immersed) in the container (Cx) to control the limits of the water level in the boiling

chamber (Bx), where the additional role of adding the small container (Cx) is the avoidance of oxidation that the two electrodes (EL3) and (EL4) will undergo at the high temperature of the boiling chamber (Bx). The terminal 9 99

of RLx is connected to the metallic part of the container (Cx), and terminal of RLx is connected to, and terminal 66 of RLx is connected to one receiver of the solenoid electromagnetic valve (HMV) and its other recipient of (HMV) is connected to −12V.

of RLx is connected to +12 Volt the metallic part of the container (Cx), and terminal 5+55

of RLx is connected to +12 Volt, and terminal 6 of RLx is connected to one receiver of the solenoid electromagnetic valve (HMV) and its other recipient of (HMV) is connected to −12V.

7. An electromagnetic valve ˜12V (HMV), one end of which is connected via a polyethylene strength tube (tuborama), either by the water supply network (WSN) (faucet, tap) or by a tank heated by a solar panel, the other end (outlet) of the (HMV) valve is connected to the said container (Cx) in which water, {from the water supply network (WSN)}, of controlled quantity enters by a level regulator (RLx). -12V, that is connected and controls the (EMV) valve with the two electrodes mentioned—sensors (EL3) and (EL4) inside the container for adjustable filling of the boiling chamber (Bx), which communicates with this container (Cx) and checks the level limits in the boiling chamber (Bx).

8. A power supply (PSx) 12 Volt, transformer to transform 230 Volt AC to 12 Volt DC.

9. A rectifier circuit with diode and capacitor (DCF) (filter) for smoothing parasitic electromagnetic waves of AC and DC supply voltage, (reduction of ripple), (alternatively is not necessary).

10. An electric heater with ohmic resistance heating (CE) as one of the mechanisms of economical heating for the purpose of boiling and mild or rapid evaporation of charged water at a temperature lower than or above 100° C., depending on the water vapor pressure on the water surface and which temperature decreases due to the high escape velocity of the water vapor from the exit of the boiling chamber (Bx), when airflow is channeled into the piping network in the same direction as the water vapor moves, increasing their speed, resulting in a decrease in pressure on the boiling surface and therefore a decrease in boiling temperature, and a rapid evaporation of the contaminated (loaded) with harmful substances water.

As an alternative, various other mechanisms can be used for economical heating that is by microwaves, infrared radiation and reflectors, photovoltaic, ultrasonic, pulsed ion movements in water, absorbing solar radiation from the black body, with rod and carbon coil and W thread, by applying alternating magnetic field (a.m.f.), produced by the coil to which the Vac is applied which sets in alternating rotary motion (a.r.m.) the ions within the water around magnetic lines (m.l.), etc.

11. A complete circuit with current amplifier RLx, 12 Vol level regulator, whose terminal (2) is connected to phase (L) and terminal 10 to neutral (N) in the general switch (S1), terminals (3) and (4) are connected to the two electrodes-sensors (EL3) and (EL4).

12a. A general switch (S1) to start or stop the operation of the device,

12b. A special switch (S2) for switching off or on supplying electricity to an electric heater with ohmic resistance heating (CE) as one of the fast mechanisms of economical heating

13a. A thermostat (Tx) to stop the operation of the heating mechanism at a predetermined given temperature e.g. 70° C.

13b. A multifunction adjustable thermostat (ATx) to stop the operation of the appliance and the heating mechanism at an adjustable temperature.

14. a relay (Rx) connected to a float (Fx) (alternatively are not necessary) with an adjustable length pin (Sx), which comes in contact with the metallic cover (Mx), which is insulated from the cover (NRV) of the stainless steel chamber of the drinking water collection (Gx), which (Mx) is connected to +12V and the pin (Sx), comes in contact with the metallic cover (Mx) connected to +12V at the predetermined maximum level of drinking water (PO), (up to the selected limit of the highest level), for automatic control of filling the chamber with drinking water (PO), with consequent automatic shutdown of the heating mechanism (CE).

15. A rapid airflow (FFAX)×2 mechanism in the same direction as the movement of water vapor (an air inlet pump to the water vapor) increasing the evaporation rate of water vapor from the surface of boiling water, resulting in an increase in evaporation rate.

16. A powerful blower (BLx 12V) as a powerful air-cooled and compression mechanism −12 Volt, water vapor liquefaction.

17. A timer (Tix) (alternatively is not necessary) for device operation for a certain period of time.

18. A non-return valve (VT).

19. A thermoelectric cooling mechanism (P) (Peltier effect), (alternatively is not necessary).

20. A horizontal layer of suitable materials (SM) (alternatively is not necessary) in the drinking water chamber and an air flow mechanism to the mattress to liquefy the water vapor and improve the quality of the water. FIG. 2 shows an alternative view of the layout of FIG. 1, which according to the present invention is characterized by the fact that it consists of the same parts as FIG. 1, with the difference that it has different connections to switches (S1) &amp; (S2) and not includes a relay and a float. FIG. 2 also includes an additional (Gx2) chamber for drinking water and pipe FA3 to transport drinking water to (Gx2).

FIG. 3 also shows an alternative aspect of the layout of FIG. 1, with the difference that it has different connections on switches (S1) and (S2).

1. An arrangement for conversion of contaminated water with harmful elements into certified ecological, healthy water, with natural cleaning without filters, is characterized by a system, the system includes:
one stainless steel chamber for boiling and two stainless steel chambers for drinking water,
a pipe with two rectangular corners to transport drinking water to the second chamber for drinking water,
a small pot preferably cylindrical which communicates with a tap outlet and with the boiling chamber preferably through the bottoms of the small pot and the boiling chamber via a metal pipe,
two electrodes which enter into the pot through the upper cover, wherein one electrode is connected to an electronic circuit as a level regulator for level control and the other electrode is connected to an electromagnetic solenoid valve for automatic filling of the boiling chamber,
a spiral stainless steel pipe connects airtightly the drinking water chamber with the boiler chamber via a stainless steel vertical pipe to separate water vapor from non-potable water droplets, wherein the generated steam in the boiling chamber is liquefied inside the spiral pipe by air flow cooling and transferred to the drinking water chamber,
two taps one for drinking water outlet connected to the drinking water chamber and another tap for contaminated water outlet, connected to the boiling water chamber, wherein the water is contaminated with harmful elements boiled for 24 hours and above,
a main power switch and another switch that connects to 240 V-AC the ohmic resistance of the electric heater which is in contact with the external side of bottom of boiling water chamber, the heating for boiling water is done with Volt in ohmic resistance, with microwaves, with infrared radiation, with reflectors, with photovoltaics, with ultrasound, with ion pulse movements in water, with solar radiation, with alternating rotational ion motion around magnetic lines,
a relay with a float to automatically control the filling of the drinking water chamber,
a powerful water vapor cooling mechanism is an external rapid flow of air to the spiral pipe, wherein the generated steam in the boiling chamber moves inside the spiral pipe towards the drinking water chamber,
a timer to stop the operation of the device after the desired operating time and the desired amount of drinking water,
a mechanism for liquefying water vapor entering the drinking water chamber,
a microprocessor and a microcontroller to coordinate the operation of the entire system for economical production and increase of the quantity of drinking water.

2. The arrangement, for conversion of contaminated water with harmful elements into certified ecological, healthy water, with natural cleaning without filters, is characterized by the fact that the system includes according to the claim 1:
a stainless steel chamber for boiling water loaded with harmful elements, with regulation of a limit temperature,
a small pot preferably cylindrical and very close to the boiling chamber, communicates with this boiling chamber, preferably through the bottoms via a metal pipe, wherein the axis of the cylindrical pot is vertical and parallel to or equal to or greater than the axis of the boiling chamber and the bottom of the cylindrical pot is at the same height as the bottom of the boiling chamber,
two electrodes sensors which enter into the communicating pot through the upper cover to control the water level in the boiling chamber, wherein one electrode is connected to an electronic circuit as a level regulator for level control and the other electrode is connected to an electromagnetic solenoid valve for automatic filling of the boiling chamber, as the role of the small pot is the elimination of parasitic electromagnetic fluctuations due to the fluctuations of the surface by boiling water and the avoidance of the oxidation that the two electrodes will undergo at the high temperature of the boiling chamber, that is the two electrodes will be subjected to its high temperature boiling chamber.

3. The arrangement, for conversion of contaminated water with harmful elements into certified ecological, healthy water, with natural cleaning without filters, is characterized by the fact that the system includes according to claim 1:
a stainless steel chamber for drinking water with a metal cover, which is connected to a spiral-shaped stainless steel tube as a helical coil for water vapor cooling with air, where one end of the spiral tube helical coil communicates with the drinking water chamber at the other end communicates with the boiling chamber via a stainless steel vertical pipe to separate water vapor from non-potable water droplets, two taps one for drinking water outlet connected to the drinking water chamber and the other one tap for waste contaminated water outlet, connected to the boiling water chamber, where the water boiled for 24 hours and above has been contaminated with harmful elements.

4. The arrangement for conversion of contaminated water with harmful elements into certified ecological, healthy water, with natural cleaning without filters, is characterized by the fact that the system includes according to claim 1: a set level regulator 12 Volt, whose terminal (2) is connected to the phase (L) and the terminal (10) with neutral (N) on the main switch (S1), terminals (3) and (4) are connected to two electrode sensors, immersed in the small pot, for adjustable filling of the boiling chamber communicating with this small pot and the boiling point level limits are controlled during boiling with the aid of the level regulator and the solenoid valve HM 12 Volt, the inlet of which is connected via a pipe to the water supply network or with a heated solar panel, and the other end of the HM 12 Volt solenoid valve is connected to said pot into which a specified amount of water controlled by the water supply enters network from the aforementioned set level regulator 12 Volt, which controls HM valve together with the, two electrode sensors inside the pot the terminal (9) is connected to the metal part of the pot the terminal (5) is connected to +12 Volt, the terminal (6) is connected to a receiver of the HM solenoid valve and another HM valve receiver is connected to −12 Volt.

5. The arrangement, for conversion of contaminated water with harmful elements into certified ecological, healthy water, with natural cleaning without filters, is characterized by the fact that the system includes according to claim 1: a rectifier circuit with diode and capacitor to normalize the parasitic electromagnetic fluctuations of the AC and DC supply voltage and reduction of the ripple.

6. The arrangement for conversion of contaminated water with harmful elements into certified ecological, healthy water, with natural cleaning without filters, is characterized by the fact that the system includes according to claim 1, a main power switch to start or stop the operation of the device and another switch that connects to 240 V-AC the ohmic resistance supplying electric power to the electric heater which is in contact with the bottom of boiling water chamber, heating for boiling water is done by applying 240 Volt in ohmic resistance as one of the fast mechanisms of economical heating, heating for boiling water is done with microwaves, with infrared radiation by reflectors, with photovoltaics, with ion pulse movements in water, with absorption of solar radiation by a black body, with application of alternating magnetic field produced by a coil to which Vac is applied, with alternating rotary motion of ions into the water around magnetic lines, a thermostat for interruption of the operation of the mechanism heating to a predetermined given temperature, a multi-function adjustable thermostat for stopping the operation of the appliance and the heating mechanism at an adjustable temperature.

7. The arrangement for conversion of contaminated water with harmful elements into certified ecological, healthy water, with natural cleaning without filters, is characterized by the fact that the system includes according to claim 1: a relay connected to a float and with an adjustable length pin, which comes in contact with the metallic cover which is insulated from the cover of the stainless steel chamber of the drinking water collection and this insulated metallic cover is connected to +12V and the pin comes in contact with the insulated metallic cover connected to +12V at the predetermined maximum level of drinking water, up to the selected maximum limit of the highest level, for automatic control of filling the chamber with drinking water, with the consequence of the automatic interruption of the operation of the heating mechanism.

8. The arrangement for conversion of contaminated water with harmful elements into certified ecological, healthy water, with natural cleaning without filters, is characterized by the fact that the system includes according to claim 1: a mechanism for the introduction of fast air flow in the same direction as the movement of water vapor increasing the rate of evaporation of water vapor from the surface of the boiling water, a powerful air-cooled mechanism, water vapor liquefaction, with multi-rotor fan, a thermoelectric cooling (Peltier effect), a timer to operate the device for a certain period of time.

9. The arrangement for conversion of contaminated water with harmful elements into certified ecological, healthy water, with natural cleaning without filters, is characterized by the fact that the system includes according to claim 1: a continuous and alternating current power supply mechanism, producing magnetic fields along the movement of water vapor in the opposite direction of the water vapor flow, preventing the escape of certain ions, two metallic plates with opposite polarity electrodes, which create a vertical electric field to the motion, also preventing certain ions from escaping and thus improving water quality.

10. The arrangement for conversion of contaminated water with harmful elements into certified ecological, healthy water, with natural cleaning without filters, is characterized by the fact that the system includes according to claim 1: a horizontal layer of suitable materials in the drinking water chamber and an airflow and water vapor flow mechanism to horizontal layer to liquefy water vapor and improve water quality, enriching it with useful elements, a mechanism transfers the water vapor that has not been liquefied to the drinking water chamber, a microcontroller or a microprocessor to coordinate the operation of the entire system for economical production, quality improvement and increase in the amount of drinking water.

11. An arrangement for conversion of contaminated water with harmful elements into certified ecological, healthy water, with natural cleaning without filters, is characterized by a system, the system includes:
one stainless steel chamber for boiling and two stainless steel chambers for drinking water,
a pipe with two rectangular corners to transport drinking water to the second chamber for drinking water,
a small pot preferably cylindrical which communicates with a tap outlet and with the boiling chamber preferably through the bottoms of the small pot and the boiling chamber via a metal pipe,
two electrodes which enter into the pot through the upper cover, wherein one electrode is connected to an electronic circuit as a level regulator for level control and the other electrode is connected to an electromagnetic solenoid valve for automatic filling of the boiling chamber,
a spiral stainless steel pipe connects airtightly the drinking water chamber with the boiler chamber via a stainless steel vertical pipe to separate water vapor from non-potable water droplets, wherein the generated steam in the boiling chamber is liquefied inside the spiral pipe by air flow cooling and transferred to the drinking water chamber,
two taps one for drinking water outlet connected to the drinking water chamber and another tap for contaminated water outlet, connected to the boiling water chamber, wherein the water is contaminated with harmful elements boiled for 24 hours and above,
a main power switch and another switch that connects to 240 V-AC the ohmic resistance of the electric heater which is in contact with the external side of bottom of boiling water chamber, the heating for boiling water is done with Volt in ohmic resistance, with microwaves, with infrared radiation, with reflectors, with photovoltaics, with ultrasound, with ion pulse movements in water, with solar radiation, with alternating rotational ion motion around magnetic lines,
a relay with a float to automatically control the filling of the drinking water chamber,
a powerful water vapor cooling mechanism is an external rapid flow of air to the spiral pipe, wherein the generated steam in the boiling chamber moves inside the spiral pipe towards the drinking water chamber,
a timer to stop the operation of the device after the desired operating time and the desired amount of drinking water,
a mechanism for liquefying water vapor entering the drinking water chamber,
a microprocessor and a microcontroller to coordinate the operation of the entire system for economical production and increase of the quantity of drinking water
a stainless steel chamber for boiling water loaded with harmful elements, with regulation of a limit temperature,
a small pot preferably cylindrical and very close to the boiling chamber, communicates with this boiling chamber, preferably through the bottoms via a metal pipe, wherein the axis of the cylindrical pot is vertical and parallel to or equal to or greater than the axis of the boiling chamber and the bottom of the cylindrical pot is at the same height as the bottom of the boiling chamber,
two electrodes sensors which enter into the communicating pot through the upper cover to control the water level in the boiling chamber, wherein one electrode is connected to an electronic circuit as a level regulator for level control and the other electrode is connected to an electromagnetic solenoid valve for automatic filling of the boiling chamber, as the role of the small pot is the elimination of parasitic electromagnetic fluctuations due to the fluctuations of the surface by boiling water and the avoidance of the oxidation that the two electrodes will undergo at the high temperature of the boiling chamber, that is the two electrodes will be subjected to its high temperature boiling chamber.

12. The arrangement, for conversion of contaminated water with harmful elements into certified ecological, healthy water, with natural cleaning without filters, is characterized by the fact that the system includes according to claim 11:
a stainless steel chamber for drinking water with a metal cover, which is connected to a spiral-shaped stainless steel tube as a helical coil for water vapor cooling with air, where one end of the spiral tube helical coil communicates with the drinking water chamber at the other end communicates with the boiling chamber via a stainless steel vertical pipe to separate water vapor from non-potable water droplets, two taps one for drinking water outlet connected to the drinking water chamber and the other one tap for waste contaminated water outlet, connected to the boiling water chamber, where the water boiled for 24 hours and above has been contaminated with harmful elements.

13. The arrangement for conversion of contaminated water with harmful elements into certified ecological, healthy water, with natural cleaning without filters, is characterized by the fact that the system includes according to claim 12: a horizontal layer of suitable materials in the drinking water chamber and an airflow and water vapor flow mechanism to horizontal layer to liquefy water vapor and improve water quality, enriching it with useful elements, a mechanism transfers the water vapor that has not been liquefied to the drinking water chamber, a microcontroller or a microprocessor to coordinate the operation of the entire system for economical production, quality improvement and increase in the amount of drinking water.

14. The arrangement for conversion of contaminated water with harmful elements into certified ecological, healthy water, with natural cleaning without filters, is characterized by the fact that the system includes according to claim 13: a set level regulator 12 Volt, whose terminal (2) is connected to the phase (L) and the terminal (10) with neutral (N) on the main switch (S1), terminals (3) and (4) are connected to two electrode sensors, immersed in the small pot, for adjustable filling of the boiling chamber communicating with this small pot and the boiling point level limits are controlled during boiling with the aid of the level regulator and the solenoid valve HM 12 Volt, the inlet of which is connected via a pipe to the water supply network or with a heated solar panel, and the other end of the HM 12 Volt solenoid valve is connected to said pot into which a specified amount of water controlled by the water supply enters network from the aforementioned set level regulator 12 Volt, which controls HM valve together with the, two electrode sensors inside the pot the terminal (9) is connected to the metal part of the pot the terminal (5) is connected to +12 Volt, the terminal (6) is connected to a receiver of the HM solenoid valve and another HM valve receiver is connected to −12 Volt.

15. The arrangement, for conversion of contaminated water with harmful elements into certified ecological, healthy water, with natural cleaning without filters, is characterized by the fact that the system includes according to claim 14: a rectifier circuit with diode and capacitor to normalize the parasitic electromagnetic fluctuations of the AC and DC supply voltage and reduction of the ripple.

16. The arrangement for conversion of contaminated water with harmful elements into certified ecological, healthy water, with natural cleaning without filters, is characterized by the fact that the system includes according to claim 15, a main power switch to start or stop the operation of the device and another switch that connects to 240 V-AC the ohmic resistance supplying electric power to the electric heater which is in contact with the bottom of boiling water chamber, heating for boiling water is done by applying 240 Volt in ohmic resistance as one of the fast mechanisms of economical heating, heating for boiling water is done with microwaves, with infrared radiation by reflectors, with photovoltaics, with ion pulse movements in water, with absorption of solar radiation by a black body, with application of alternating magnetic field produced by a coil to which Vac is applied, with alternating rotary motion of ions into the water around magnetic lines, a thermostat for interruption of the operation of the mechanism heating to a predetermined given temperature, a multi-function adjustable thermostat for stopping the operation of the appliance and the heating mechanism at an adjustable temperature.

17. An arrangement for conversion of contaminated water with harmful elements into certified ecological, healthy water, with natural cleaning without filters, is characterized by a system, the system includes:
one stainless steel chamber for boiling and two stainless steel chambers for drinking water,
a pipe with two rectangular corners to transport drinking water to the second chamber for drinking water,
a small pot preferably cylindrical which communicates with a tap outlet and with the boiling chamber preferably through the bottoms of the small pot and the boiling chamber via a metal pipe,
two electrodes which enter into the pot through the upper cover, wherein one electrode is connected to an electronic circuit as a level regulator for level control and the other electrode is connected to an electromagnetic solenoid valve for automatic filling of the boiling chamber,
a spiral stainless steel pipe connects airtightly the drinking water chamber with the boiler chamber via a stainless steel vertical pipe to separate water vapor from non-potable water droplets, wherein the generated steam in the boiling chamber is liquefied inside the spiral pipe by air flow cooling and transferred to the drinking water chamber,
two taps one for drinking water outlet connected to the drinking water chamber and another tap for contaminated water outlet, connected to the boiling water chamber, wherein the water is contaminated with harmful elements boiled for 24 hours and above,
a main power switch and another switch that connects to 240 V-AC the ohmic resistance of the electric heater which is in contact with the external side of bottom of boiling water chamber, the heating for boiling water is done with Volt in ohmic resistance, with microwaves, with infrared radiation, with reflectors, with photovoltaics, with ultrasound, with ion pulse movements in water, with solar radiation, with alternating rotational ion motion around magnetic lines,
a relay with a float to automatically control the filling of the drinking water chamber,
a powerful water vapor cooling mechanism is an external rapid flow of air to the spiral pipe, wherein the generated steam in the boiling chamber moves inside the spiral pipe towards the drinking water chamber,
a timer to stop the operation of the device after the desired operating time and the desired amount of drinking water,
a mechanism for liquefying water vapor entering the drinking water chamber,
a microprocessor and a microcontroller to coordinate the operation of the entire system for economical production and increase of the quantity of drinking water,
a set level regulator 12 Volt, whose terminal (2) is connected to the phase (L) and the terminal (10) with neutral (N) on the main switch (S1), terminals (3) and (4) are connected to two electrode sensors, immersed in the small pot, for adjustable filling of the boiling chamber communicating with this small pot and the boiling point level limits are controlled during boiling with the aid of the level regulator and the solenoid valve HM 12 Volt, the inlet of which is connected via a pipe to the water supply network or with a heated solar panel, and the other end of the HM 12 Volt solenoid valve is connected to said pot into which a specified amount of water controlled by the water supply enters network from the aforementioned set level regulator 12 Volt, which controls HM valve together with the, two electrode sensors inside the pot the terminal (9) is connected to the metal part of the pot the terminal (5) is connected to +12 Volt, the terminal (6) is connected to a receiver of the HM solenoid valve and another HM valve receiver is connected to −12 Volt.

18. The arrangement for conversion of contaminated water with harmful elements into certified ecological, healthy water, with natural cleaning without filters, is characterized by the fact that the system includes according to claim 17: a relay connected to a float and with an adjustable length pin, which comes in contact with the metallic cover which is insulated from the cover of the stainless steel chamber of the drinking water collection and this insulated metallic cover is connected to +12V and the pin comes in contact with the insulated metallic cover connected to +12V at the predetermined maximum level of drinking water, up to the selected maximum limit of the highest level, for automatic control of filling the chamber with drinking water, with the consequence of the automatic interruption of the operation of the heating mechanism.

19. The arrangement for conversion of contaminated water with harmful elements into certified ecological, healthy water, with natural cleaning without filters, is characterized by the fact that the system includes according to claim 18: a mechanism for the introduction of fast air flow in the same direction as the movement of water vapor increasing the rate of evaporation of water vapor from the surface of the boiling water, a powerful air-cooled mechanism, water vapor liquefaction, with multi-rotor fan, a thermoelectric cooling (Peltier effect), a timer to operate the device for a certain period of time.

20. The arrangement for conversion of contaminated water with harmful elements into certified ecological, healthy water, with natural cleaning without filters, is characterized by the fact that the system includes according to claim 19: a horizontal layer of suitable materials in the drinking water chamber and an airflow and water vapor flow mechanism to horizontal layer to liquefy water vapor and improve water quality, enriching it with useful elements, a mechanism transfers the water vapor that has not been liquefied to the drinking water chamber, a microcontroller or a microprocessor to coordinate the operation of the entire system for economical production, quality improvement and increase in the amount of drinking water.
